(19) United States
(12) Patent Application Publication
(10) Pub. No.: US 2025/0136069 A1
(43) Pub. Date: May 1, 2025

(54) SYSTEMS AND METHODS FOR OPERATING A REFUSE VEHICLE

(71) Applicant: Oshkosh Corporation, Oshkosh, WI (US)

(72) Inventors: Vince Schad, Oshkosh, WI (US); Andy Cornelius, Oshkosh, WI (US); Nick Weykamp, Oshkosh, WI (US); Quincy Wittman, Oshkosh, WI (US); Jerrod Kappers, Oshkosh, WI (US); Brendan Chan, Oshkosh, WI (US); Eric Olson, Oshkosh, WI (US); Zhenyi Wei, Oshkosh, WI (US); Alec Ehlke, Oshkosh, WI (US); Jeff Meyer, Oshkosh, WI (US); Umang Patel, Oshkosh, WI (US); Austin Mahoney, Oshkosh, WI (US); Thomas Vale, Oshkosh, WI (US); William Young, Elmira, NY (US); Johnny Bui, Oshkosh, WI (US); Nagabhushana Sharma Gurumurthy, Oshkosh, WI (US)

(73) Assignee: Oshkosh Corporation, Oshkosh, WI (US)

(21) Appl. No.: 18/926,796

(22) Filed: Oct. 25, 2024

Related U.S. Application Data
(60) Provisional application No. 63/545,972, filed on Oct. 27, 2023.

(51) Int. Cl. B60T 7/12; B60N 2/00; B60Q 9/00; B60T 8/17; B60T 8/171

(52) U.S. Cl. CPC B60T 7/12; B60N 2/0024; B60Q 9/00; B60T 8/1701; B60T 8/171; B60T 2210/32; B60T 2220/00

(57) ABSTRACT

A refuse vehicle includes a driveline configured to transport the refuse vehicle, a cab defining a cab opening configured to receive an operator of the refuse vehicle therein, one or more sensors configured to generate sensor data corresponding to at least one of the refuse vehicle or the operator, and one or more processing circuits. The one or more processing circuits are configured to acquire, from the sensors, the sensor data, determine, based on the sensor data, an operator of the refuse vehicle is at least one of exiting the cab opening or is positioned outside of the cab opening, determine, based on the sensor data, that the refuse vehicle is in a non-parking configuration, and operate the refuse vehicle to place the refuse vehicle in a parking configuration.

This application claims the benefit of and priority to U.S. Provisional Patent Application No. 63/545,972, filed Oct. 27, 2023, which is incorporated herein by reference in its entirety.

### BACKGROUND

The present disclosure generally relates to the field of refuse vehicles. More specifically, the present disclosure relates to control systems for refuse vehicles.

### SUMMARY

One embodiment of the present disclosure relates to a refuse vehicle. The refuse vehicle includes a driveline configured to transport the refuse vehicle, a cab defining a cab opening configured to receive an operator of the refuse vehicle therein, one or more sensors configured to generate sensor data corresponding to at least one of the refuse vehicle or the operator, and one or more processing circuits. The one or more processing circuits are configured to acquire, from the sensors, the sensor data, determine, based on the sensor data, an operator of the refuse vehicle is at least one of exiting the cab opening or is positioned outside of the cab opening, determine, based on the sensor data, that the refuse vehicle is in a non-parking configuration, and operate the refuse vehicle to place the refuse vehicle in a parking configuration.

Another embodiment of the present disclosure relates to a refuse vehicle. The refuse vehicle includes a driveline configured to transport the refuse vehicle, a cab defining a cab opening configured to receive an operator of the refuse vehicle therein, one or more sensors configured to generate sensor data corresponding to at least one of the refuse vehicle or the operator, an awareness system configured to generate awareness data corresponding to surroundings of the refuse vehicle, and one or more processing circuits. The one or more processing circuits are configured to acquire, from the one or more sensors, the sensor data, determine, based on the sensor data, a position of the operator, acquire, from the awareness system, the awareness data, determine, based on the awareness data, an object is approaching the position of the operator, and operate the refuse vehicle to generate a contact alert such that the operator is alerted the object is approaching the position of the operator.

Yet another embodiment of the present disclosure relates to method for operating a refuse vehicle. The method includes acquiring, from one or more sensors of the refuse vehicle, sensor data corresponding to the refuse vehicle, determining, based on the sensor data, an operator of the refuse vehicle is positioned outside of the refuse vehicle, determining, based on the sensor data, the refuse vehicle is in a non-parking configuration, and operating the refuse vehicle to at least one of generate a parking alert or place the refuse vehicle in a parking configuration.

Another embodiment of the present disclosure relates to a refuse vehicle. The refuse vehicle includes a cab, an awareness system, and processing circuitry. The cab includes a door, a seat support, a seat belt, at least one user interface component, and a plurality of sensors. The door is configured to provide access to a cab interior of the cab. The seat support is configured to support an operator of the refuse vehicle. The seat belt is configured to secure the operator to the seat support. The user interface component is configured to facilitate operator control over the refuse vehicle. The sensors are configured to obtain sensor data relating to a configuration of at least one of the door, the seat support, the seat belt, or the user interface component. The awareness system is configured to obtain awareness data relating to objects in a surrounding area proximate the refuse vehicle. The processing circuitry is configured to obtain the sensor data or the awareness data indicating that the operator is exiting the cab of the refuse vehicle or that the operator is positioned outside of the refuse vehicle. The processing circuitry is also configured to predict, based on the awareness data, that the operator may come in contact with an object in the surrounding area. The processing circuitry is also configured to perform at least one of generating a contact alert or operating the refuse vehicle so that the operator may not come in contact with the object.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a block diagram of a control system for any of the refuse vehicles of FIGS. 1-3, according to an exemplary embodiment;

FIG. 5 is a diagram illustrating a collection route for autonomous transport and collection by any of the refuse vehicles of FIGS. 1-3, according to an exemplary embodiment;

FIG. 6 is a perspective view of a cab of any of the refuse vehicles of FIGS. 1-3, according to an exemplary embodiment;

FIG. 7 is a top view of the cab of FIG. 6, according to an exemplary embodiment;

FIG. 8A is a top view of an awareness system of any of the refuse vehicles of FIGS. 1-3, according to an exemplary embodiment;

FIG. 8B is a top view of the awareness system of FIG. 8A showing camera sensing arcs for camera sensors of the awareness system, according to an exemplary embodiment;

FIG. 8C is a top view of the awareness system of FIG. 8A showing a combination of radar and camera sensors, according to an exemplary embodiment.

FIG. 9 is a top view of an environment depicting the awareness system of FIG. 8, according to an exemplary embodiment;

FIG. 10 is a block diagram of a wearable system for any of the refuse vehicles of FIGS. 1-3, according to an exemplary embodiment;

FIG. 11 is a top view of an environment depicting the wearable system of FIG. 10, according to an exemplary embodiment;

FIG. 12 is a block diagram of a control system for any of the refuse vehicles of FIGS. 1-3, according to an exemplary embodiment;

FIG. 13 is a block diagram of a controller of the control system of FIG. 12, according to an exemplary embodiment;

FIG. 14 is a flow diagram for a process for safely exiting a refuse vehicle, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the FIGURES, a refuse vehicle includes multiple sensors that are configured to identify when the refuse vehicle is stopped and when an operator of the refuse vehicle is exiting the refuse vehicle or is positioned outside of the refuse vehicle. For example, the multiple sensors can include a GPS system configured to determine that the refuse vehicle is stopped, and a door sensor configured to monitor a condition of a door of a cab of the refuse vehicle. One or more processing circuits of the refuse vehicle may obtain sensor data from the multiple sensors can be analyzed to identify that the refuse vehicle is stopped, and that the operator of the refuse vehicle is exiting the refuse vehicle or is positioned outside of the refuse vehicle and whether the refuse vehicle is in a parked configuration. The one or more processing circuits may generate a parking alert or operate the refuse vehicle to place the vehicle in the parked configuration.

The refuse vehicle may also include an awareness system configured to detect objects in a surrounding area proximate the refuse vehicle. For example, the awareness system can be configured to detect a second vehicle, refuse containers, trees, etc. The awareness system can include at least one of externally mounted or outwards facing radar sensors configured to obtain radar data or externally mounted or outwards facing cameras configured to obtain image data. The radar data and/or the image data can be analyzed to identify an object in the surrounding area proximate the refuse vehicle. The one or more processing circuits of the refuse vehicle may predict that the operator of the refuse vehicle may come in contact with the object. The one or more processing circuits may generate a contact alert or operate the refuse vehicle such that the operator may not come in contact with the object.

The refuse vehicle may also include a wearable system configured to detect a position of a wearable device worn by an operator of the refuse vehicle. For example, a hard hat worn by an operator of the refuse vehicle may include a position module that can be used by the one or more processing circuits of the refuse vehicle to determine the position of the hard hat relative to the refuse vehicle. The wearable system can be configured to obtain wearable data associated with the position of the wearable device. The one or more processing circuits of the refuse vehicle may also use the wearable data to predict that the operator of the refuse vehicle may come in contact with an object.

### Refuse Vehicle

### Front-Loading Configuration

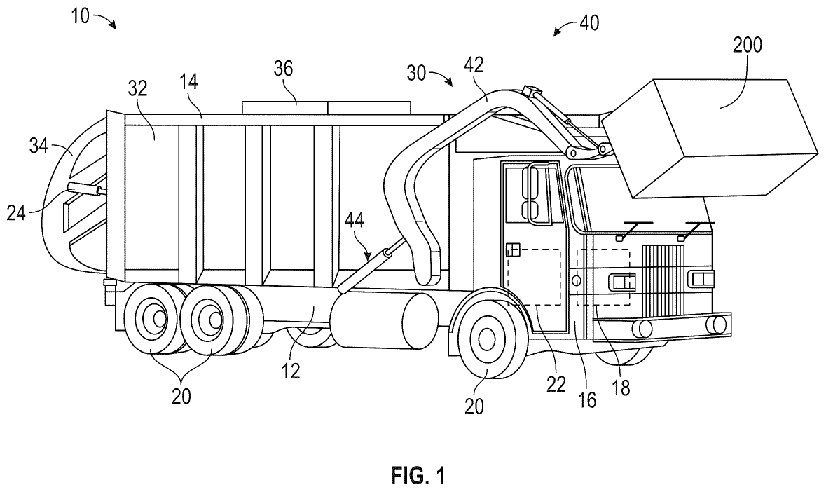

Referring to FIG. 1, a vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled to the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly (e.g., a compaction apparatus) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled to at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled to frame 12 with a pivot (e.g., a lug, a shaft, etc.). The lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled to a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the container attachment 200 as described in greater detail in U.S. application Ser. No. 17/558,183, filed Dec. 12, 2021, the entire disclosure of which is incorporated by reference herein.

### Rear-Loading Configuration

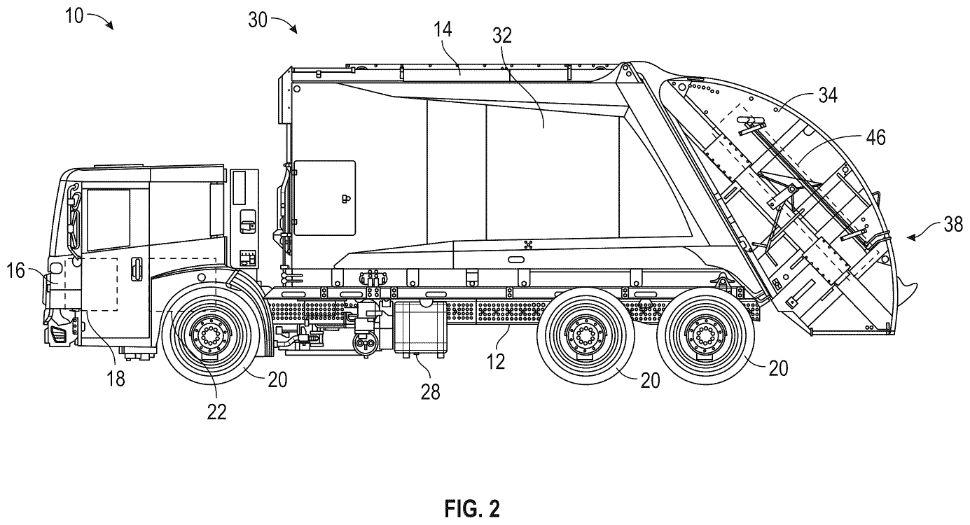

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation.

### Side-Loading Configuration

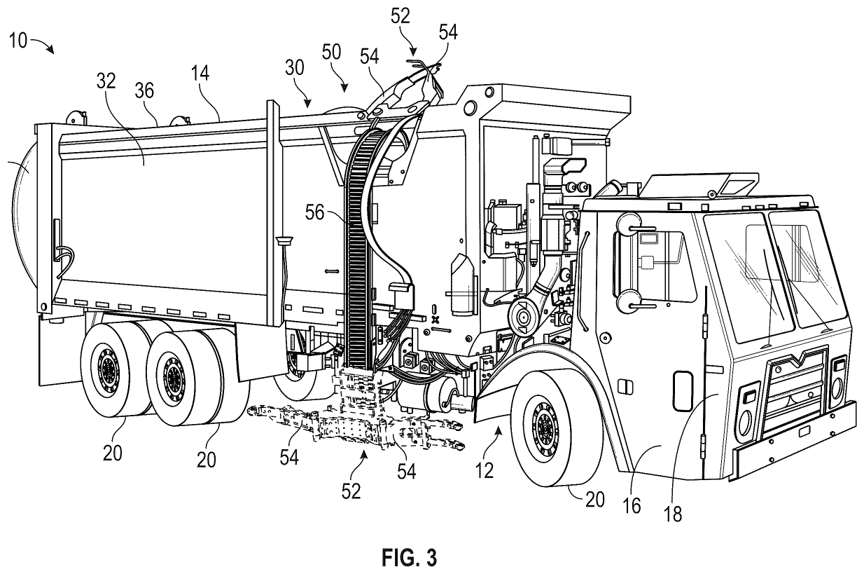

Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled to a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54. The grabber arms 54 are configured to rotate about an axis extending through a bushing. The grabber arms 54 are configured to releasably secure a refuse container to grabber assembly 52, according to an exemplary embodiment. The grabber arms 54 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54 are rotated towards each other such that the refuse container is grasped therebetween. In the disengaged state, the grabber arms 54 rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56, and return the refuse container to the ground. Once the refuse container has been placed on the ground, the grabber assembly may transition into the disengaged state, releasing the refuse container.

### Control System

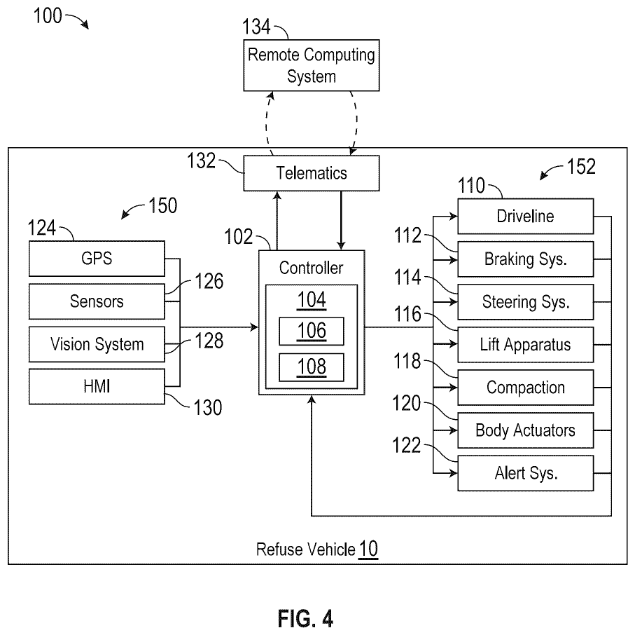

Referring to FIG. 4, the refuse vehicle 10 may include a control system 100 that is configured to facilitate autonomous or semi-autonomous operation of the refuse vehicle 10, or components thereof. The control system 100 includes a controller 102 that is positioned on the refuse vehicle 10, a remote computing system 134, a telematics unit 132, one or more input devices 150, and one or more controllable elements 152. The input devices 150 can include a Global Positioning System (“GPS”), multiple sensors 126 (e.g., a plurality of sensors, etc.), a vision system 128 (e.g., an awareness system), and a Human Machine Interface (“HMI”). The controllable elements 152 can include a driveline 110 of the refuse vehicle 10, a braking system 112 of the refuse vehicle 10, a steering system 114 of the refuse vehicle 10, a lift apparatus 116 (e.g., the lift assembly 40, the lift assembly 50, etc.), a compaction system 118 (e.g., a packer assembly, the packer 46, etc.), body actuators 120 (e.g., tailgate actuators 24, lift or dumping actuators, etc.), and/or an alert system 122.

The controller 102 includes one or more processing circuits 104 (e.g., processing circuitry, etc.) including a processor 106 and memory 108. The processing circuits 104 can be communicably connected with a communications interface of controller 102 such that the processing circuits 104 and the various components thereof can send and receive data via the communications interface. Processor 106 can be implemented as a general purpose processor, an application specific integrated circuit (ASIC), one or more field programmable gate arrays (FPGAs), a group of processing components, or other suitable electronic processing components.

Memory 108 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 108 can be or include volatile memory or non-volatile memory. Memory 108 can include database components, object code components, script components, or any other type of information structure for supporting the various activities and information structures described in the present application. According to some embodiments, memory 108 is communicably connected to processor 106 via the processing circuits 104 and includes computer code for executing (e.g., by at least one of the processing circuits 104 or processor 106) one or more processes described herein.

The controller 102 is configured to receive inputs (e.g., measurements, detections, signals, sensor data, etc.) from the input devices 150, according to some embodiments. In particular, the controller 102 may receive a GPS location from the GPS system 124 (e.g., current latitude and longitude of the refuse vehicle 10). The controller 102 may receive sensor data (e.g., engine temperature, fuel levels, transmission control unit feedback, engine control unit feedback, speed of the refuse vehicle 10, etc.) from the sensors 126. The controller 102 may receive image data (e.g., real-time camera data) from the vision system 128 of an area of the refuse vehicle 10 (e.g., in front of the refuse vehicle 10, rearwards of the refuse vehicle 10, on a street-side or curb-side of the refuse vehicle 10, at the hopper of the refuse vehicle 10 to monitor refuse that is loaded, within the cab 16 of the refuse vehicle 10, etc.). The controller 102 may receive user inputs from the HMI 130 (e.g., button presses, requests to perform a lifting or loading operation, driving operations, steering operations, braking operations, etc.).

The controller 102 may be configured to provide control outputs (e.g., control decisions, control signals, etc.) to the driveline 110 (e.g., the engine 18, the transmission 22, the engine control unit, the transmission control unit, etc.) to operate the driveline 110 to transport the refuse vehicle 10. The controller 102 may also be configured to provide control outputs to the braking system 112 to activate and operate the braking system 112 to decelerate the refuse vehicle 10 (e.g., by activating a friction brake system, a regenerative braking system, etc.). The controller 102 may be configured to provide control outputs to the steering system 114 to operate the steering system 114 to rotate or turn at least two of the tractive elements 20 to steer the refuse vehicle 10. The controller 102 may also be configured to operate actuators or motors of the lift apparatus 116 (e.g., lift arm actuators 44) to perform a lifting operation (e.g., to grasp, lift, empty, and return a refuse container). The controller 102 may also be configured to operate the compaction system 118 to compact or pack refuse that is within the refuse compartment 30. The controller 102 may also be configured to operate the body actuators 120 to implement a dumping operation of refuse from the refuse compartment 30 (e.g., driving the refuse compartment 30 to rotate to dump refuse at a landfill). The controller 102 may also be configured to operate the alert system 122 (e.g., lights, speakers, display screens, etc.) to provide one or more aural or visual alerts to nearby individuals.

The controller 102 may also be configured to receive feedback from any of the driveline 110, the braking system 112, the steering system 114, the lift apparatus 116, the compaction system 118, the body actuators 120, or the alert system 122. The controller may provide any of the feedback to the remote computing system 134 via the telematics unit 132. The telematics unit 132 may include any wireless transceiver, cellular dongle, communications radios, antennas, etc., to establish wireless communication with the remote computing system 134. The telematics unit 132 may facilitate communications with telematics units 132 of nearby refuse vehicles 10 to thereby establish a mesh network of refuse vehicles 10.

The controller 102 is configured to use any of the inputs from any of the GPS system 124, the sensors 126, the vision system 128, or the HMI 130 to generate controls for the driveline 110, the braking system 112, the steering system 114, the lift apparatus 116, the compaction system 118, the body actuators 120, or the alert system 122. In some embodiments, the controller 102 is configured to operate the driveline 110, the braking system 112, the steering system 114, the lift apparatus 116, the compaction system 118, the body actuators 120, and/or the alert system 122 to autonomously transport the refuse vehicle 10 along a route (e.g., self-driving), perform pickups or refuse collection operations autonomously, and transport to a landfill to empty contents of the refuse compartment 30. The controller 102 may receive one or more inputs from the remote computing system 134 such as route data, indications of pickup locations along the route, route updates, customer information, pickup types, etc. The controller 102 may use the inputs from the remote computing system 134 to autonomously transport the refuse vehicle 10 along the route and/or to perform the various operations along the route (e.g., picking up and emptying refuse containers, providing alerts to nearby individuals, limiting pickup operations until an individual has moved out of the way, etc.).

In some embodiments, the remote computing system 134 is configured to interact with (e.g., control, monitor, etc.) the refuse vehicle 10 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 134 may perform any of the route planning techniques as described in greater detail in U.S. application Ser. No. 18/111,137, filed Feb. 17, 2023, the entire disclosure of which is incorporated by reference herein. The remote computing system 134 may implement any route planning techniques based on data received by the controller 102. In some embodiments, the controller 102 is configured to implement any of the cart alignment techniques as described in U.S. application Ser. No. 18/242,224, filed Sep. 5, 2023, the entire disclosure of which is incorporated by reference herein. The refuse vehicle 10 and the remote computing system 134 may also operate or implement geofences as described in greater detail in U.S. application Ser. No. 17/232,855, filed Apr. 16, 2021, the entire disclosure of which is incorporated by reference herein.

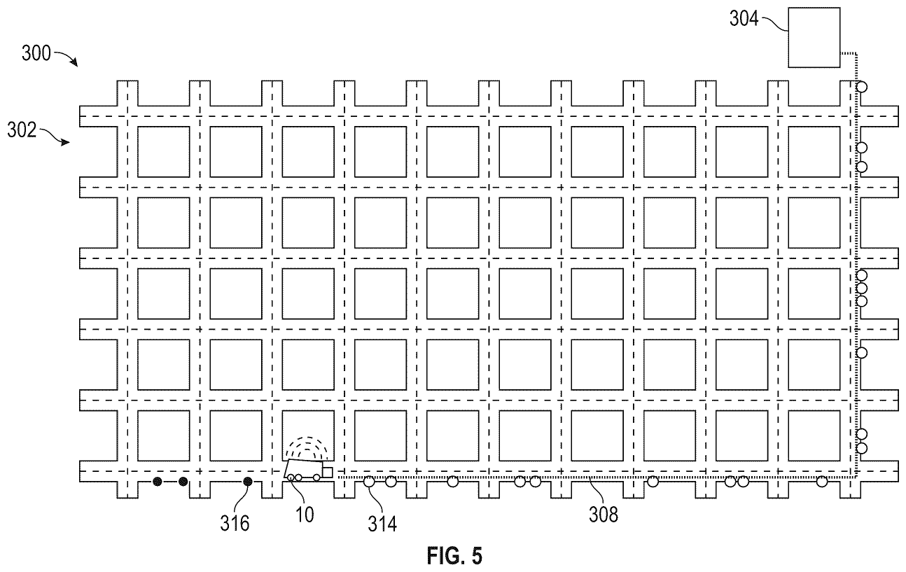

Referring to FIG. 5, a diagram 300 illustrates a route 308 through a neighborhood 302 for the refuse vehicle 10. The route 308 includes future stops 314 along the route 308 to be completed, and past stops 316 that have already been completed. The route 308 may be defined and provided by the remote computing system 134. The remote computing system 134 may also define or determine the future stops 314 and the past stops 316 along the route 308 and provide data regarding the geographic location of the future stops 314 and the past stops 316 to the controller 102 of the refuse vehicle 10. The refuse vehicle 10 may use the route data and the stops data to autonomously transport along the route 308 and perform refuse collection at each stop. The route 308 may end at a landfill 304 (e.g., an end location) where the refuse vehicle 10 may autonomously empty collected refuse, transport to a refueling location if necessary, and begin a new route.

### Cab Interior

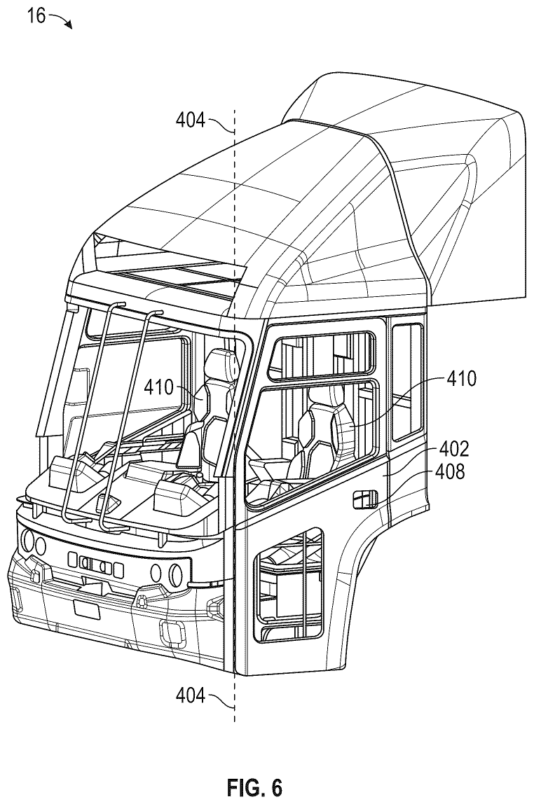

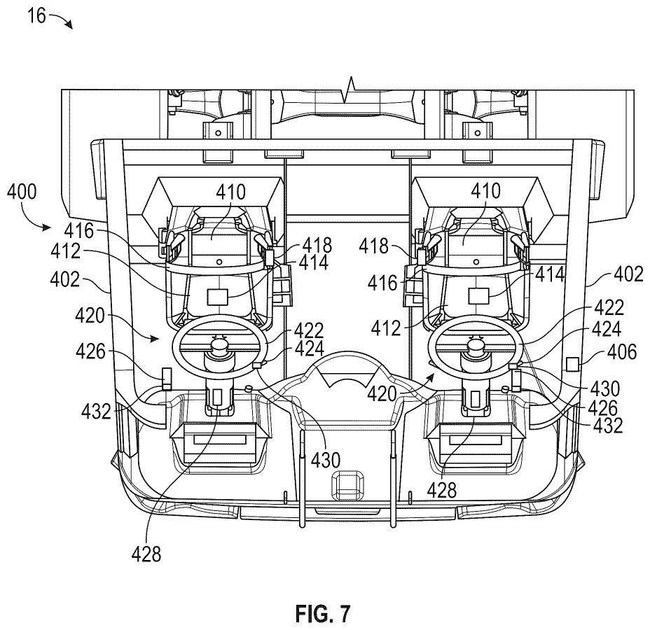

Referring to FIGS. 6 and 7, the cab 16 includes an enclosure or main body that defines an interior volume, shown as cab interior 400 that is sized to contain one or more operators. The cab 16 may include one or more doors 402 that facilitate selective access to the cab interior 400 from outside of the refuse vehicle 10. The cab interior 400 contains one or more components that facilitate operation of the refuse vehicle 10 by the operator. In one embodiment, the cab interior 400 contains at least one seat 410 configured to support the operator, at least one user interface component 420 configured to facilitate operator control over the drive components of the refuse vehicle 10 and/or over any implements of the refuse vehicle 10, and user interface components that provide information to the operators (e.g., lights, gauges, speakers, the alert system 122, etc.).

Referring still to FIGS. 6 and 7, the door 402 may be configured to move between an open position and a closed position. In some embodiments, the door 402 moves by rotating about a vertical axis, shown as axis 404. The axis 404 may be coupled with a front edge of the door 402 or a back edge of the door 402. In some embodiments, the door 402 swings inward to open the cab 16. In other embodiments, the door 402 swings outward to open the cab 16. When rotating about an axis, the door 402 may use piano hinges that are coupled to an edge of the door 402. The piano hinges may be forward or backward hinges. In other embodiments, the door 402 uses other hinges. In other embodiments, the door 402 moves by rotating about a different axis (e.g., horizontal, 45 degree, etc.). In other embodiments, the door 402 moves by being removed from the cab 16 and replaced back onto the cab 16. In other embodiments, the door 402 moves by sliding along a rail or track. In some embodiments, at least one of the sensors 126 is a door sensor 406 configured to generate sensor data (e.g., door data, etc.) corresponding to a condition of the door 402 relative to the cab 16. For example, the door sensor 406 may be a rotation sensor configured to generate sensor data corresponding to an angle between of the door 402 and the cab 16, a proximity sensor configured to generate sensor data corresponding an orientation of the door 402 (e.g., if the door 402 is in an open orientation, if the door 403 is in a closed orientation, or another type of sensor configured to generate sensor data corresponding to the door 402,

Referring to FIG. 6, in some embodiments, the door 402 includes an opening mechanism, shown as opening mechanism 408. The opening mechanism 408 may be any mechanism configured to keep the door 402 in a closed position when activated, and release the door 402 from the closed position when deactivated. Activation and deactivation of the opening mechanism 408 may selectively transition between a locked configuration where the opening mechanism 408 prevents the door 402 from being moved from the closed position (e.g., inhibit the door 402 from transitioning from the closed position, etc.) and an unlocked configuration where the opening mechanism 408 allows for the door 402 to be moved from the closed position to an open position. In some embodiments, the opening mechanism 408 is a handle. In other embodiments, the opening mechanism 408 is a lever, a button, a switch, a toggle, a latch, a knob, a handle, etc. In some embodiments, the opening mechanism 408 is disposed on a top portion of the door 402. In another embodiment, the opening mechanism 408 is disposed on a bottom portion of the door 402. The opening mechanism 408 may be placed anywhere on a side of the cab 16 such that it controls the movement of the door 402 between the open position and the closed position. In some embodiments, the door sensor 406 may be configured to generate sensor data corresponding to a condition of the opening mechanism 408. The sensor data corresponding to the condition of the opening mechanism 408 may be utilized by the controller 102 to determine attributes associated with the door 402. For example, the door sensor 406 may be configured as a latch sensor configured generate sensor data corresponding to a configuration of the opening mechanism 408 (e.g., whether the opening mechanism 408 is in the locked configuration, whether the opening mechanism 408 is in the unlocked configuration, etc.). In some embodiments, the opening mechanism 408 may be one of the controllable elements 152. For example, the controller 102 may be configured to operate the opening mechanism 408 between the unlocked configuration and the locked configuration (e.g., via an actuator, etc.).

Referring still to FIG. 7, the seat 410 may include a seat support 412 and a seat belt 416. The seat support 412 may be configured to support the operator while the operator is operating the refuse vehicle 10. According to an exemplary embodiment, as shown in FIG. 6, the seat support 412 is configured to accommodate the operator in a seated position. In such an embodiment, the seat support 412 is substantially horizontal such that a person sitting on the seat support 412 does not need additional support to remain on the seat 410 (e.g., feet do not need to be on the floor to keep the person in the seat). In other embodiments, the seat 410 is configured to accommodate the operator in a non-seated or standing configuration. In such an embodiment, the seat support 412 of the seat 410 is oriented at an angle such that a person can be in a more upright position (e.g., not arranged parallel to the ground). The standing configuration may include the person supporting themselves with their feet a floor of the cab 16. In some embodiments, at least one of the sensors 126 is a seat sensor 414 configured to generate sensor data corresponding to the seat support 412 supporting an operator. For example, the seat sensor 414 may be a pressure sensor positioned in the seat support 412 and configured to generate pressure data corresponding to a pressure applied on the seat support 412 by an operator when the seat support 412 is supporting the operator.

The seat belt 416 is configured to secure the operator to the seat support 412. In some embodiments, the seat belt 416 may be a waist belt that secures the operator to the seat support 412 around the waist of the operator. In other embodiments, the seat belt 416 may be a three-point seatbelt (e.g., a shoulder harness seat belt, a seat belt that secures the operator to the seat support 412 around the waist and over one of the shoulders of the operator, etc.), a four-point seat belt (e.g., a seat belt that secures the operator to the seat support 412 around the waist and over both of the shoulders of the operator, etc.), or another type of seat belt. In some embodiments, at least one of the sensors 126 is a seat belt sensor 418 configured to generate sensor data associated with a configuration of the seat belt 416. For example, the seat belt sensor 418 may be a proximity sensor configured to generate sensor data corresponding to whether the seat belt 416 is in a latched configuration where the seat belt 416 secures the operator to the seat support 412 or an unlatched configuration where the seat belt 416 does not secure the operator to the seat support 412. For another example, the seat belt sensor 418 may be a latch sensor configured to generate sensor data corresponding to whether a first portion of the seat belt 416 is latched in a second portion of the seat belt 416.

Still referring to FIG. 7, the user interface components 420 may include a steering input device 422 (e.g., a steering wheel, a rotatable control device, a steering device, a steering input device, a joystick, etc.), a shift input device 424 (e.g., a manual gear shifter, an automatic gear shifter, etc.), a parking brake input device 426 (e.g., a parking brake lever, a parking brake button, a parking brake switch, etc.), and other input devices that facilitate the operation of the refuse vehicle 10 by the operator. The steering input device 422 may be adjusted in order to adjust an orientation of the tractive elements 20 of the refuse vehicle 10 to complete a turn. In some embodiments, at least one of the sensors 126 is a steering input sensor 428 configured to generate sensor data corresponding with an orientation of the steering input device 422 (e.g., an angle of a steering wheel, a position of a joystick, etc.). For example, the steering input sensor 428 may be an encoder positioned on the steering input device 422 configured to generate sensor data corresponding to an angle of the steering input device, a magnetic sensor that generates sensor data corresponding to the position of the steering input device 422 based on a magnetic field, or another type of sensor that generates sensor data corresponding to the position of the steering input device 422. In some embodiments, at least one of the sensors 126 is configured to generate sensor data corresponding to the orientation of the tractive elements 20 directly (e.g., measure a property of the tractive elements 20 determine the orientation of the tractive elements 20).

The shift input device 424 may be adjusted in order to adjust an orientation of transmission 22 to change the gearing of the transmission 22. For example, the shift input device 424 may be adjusted in order to adjust the transmission from a neutral orientation to a drive orientation. The neutral orientation may correspond to the transmission 22 not transferring the output torque from the engine 18 to the tractive elements 20 and the drive orientation may correspond to the transmission 22 transferring the output torque from the engine 18 to the tractive elements 20. In some embodiments, at least one of the sensors 126 is a shift input sensor 430 configured to generate sensor data corresponding to a position of the shift input device 424. For example, the shift input sensor 430 may be a potentiometer that generates sensor data corresponding to an angle of the shift input device 424 which is associated with the orientation of the transmission 22, a magnetic sensor that uses a magnetic field to generate sensor data corresponding to a position of the shift input device 424 that is associated with the orientation of the transmission 22, or another type of sensor that generates sensor data corresponding to a position of the shift input device 424 that is associated with the orientation of the transmission 22. In some embodiments, one of the sensors 126 may be configured to generate sensor data corresponding to the orientation of the transmission 22 directly (e.g., measure a property of the transmission 22 to determine the orientation of the transmission 22).

The parking brake input device 426 may be adjusted in order to activate or deactivate a parking brake of the refuse vehicle 10 (e.g., emergency brake, handbrake, etc.). The parking brake input device 426 may selectively transition the parking brake of the refuse vehicle 10 between an activated configuration where the parking brake prevents movement of the refuse vehicle 10 (e.g., keeps the refuse vehicle 10 stationary, prevents the transport of the refuse vehicle 10, etc.) and a deactivated configuration that allows movement of the refuse vehicle 10. For example, when the parking brake is in the activated configuration, the parking brake may apply a force on at least one of the tractive elements 20 that resists movement of the tractive elements 20. In some embodiments, at least one of the sensors 126 is a parking brake sensor 432 configured to generate sensor data corresponding to a position of the parking brake input device 426 (e.g., a first position configured to engage the parking brake, a position to disengage the parking brake, etc.). For example, the parking brake sensor 432 may be a switch sensor configured to generate sensor data corresponding to a position of the parking brake input device 426 based on a switch being open or closed, an optical sensor configured to generate senor data corresponding the position of the parking brake input device 426 based on a visual indicator, or another type of sensor that is configured to generate sensor data corresponding to the position of the parking brake input device 426. In some embodiments, one of the sensors 126 may be configured to generate sensor data corresponding to the orientation of the parking brake of the refuse vehicle 10 directly (e.g., measure a property of the parking brake of the refuse vehicle 10 to determine the orientation of the parking brake of the refuse vehicle 10).

### Awareness System

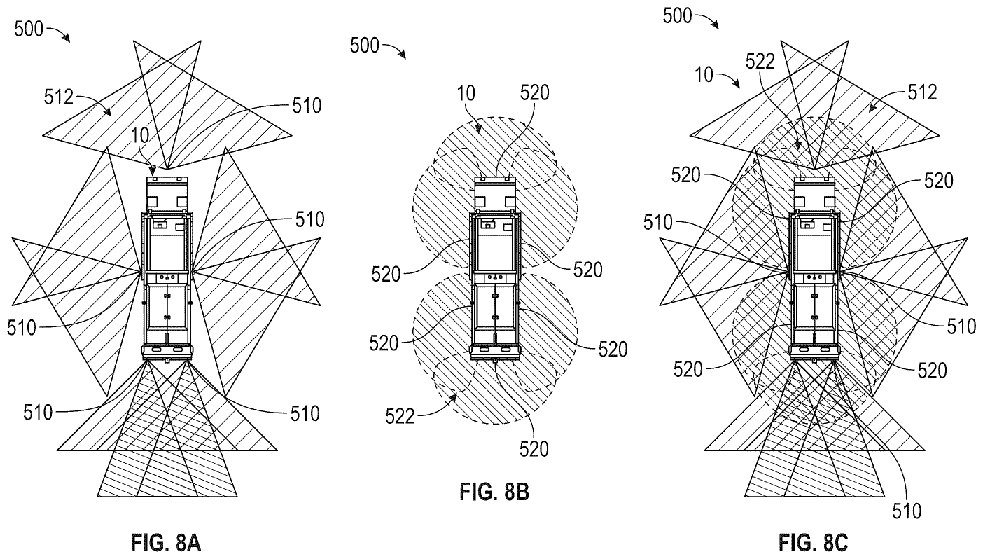

Referring to FIGS. 8A-8C, the refuse vehicle 10 includes an awareness system 500 (e.g., a detection system, a vision system, an environmental detection system, an environmental awareness system, etc.) configured to detect objects proximate the refuse vehicle 10 (e.g., objects adjacent to the refuse vehicle 10, objects approaching the refuse vehicle 10, etc.). The awareness system 500 may be configured to detect different types of objects proximate the refuse vehicle 10 such as refuse containers, vehicles, buildings, or any other object that may be proximate to the refuse vehicle 10. The awareness system 500 may use a variety of sensors, detectors, emitters, detection sub-systems, etc., to detect different types of objects. For example, the awareness system 500 may use the vision system 128 and/or multiple of the sensors 126 of the refuse vehicle 10. The awareness system 500 may implement any of the functionality as described in greater detail in U.S. application Ser. No. 17/232,367, filed Apr. 16, 2021, the entire disclosure of which is incorporated by reference herein.

Referring to FIG. 8A, the awareness system 500 of the vehicle may be configured to detect objects in a surrounding area of the refuse vehicle 10 proximate the refuse vehicle 10. In some embodiments, the awareness system 500 may include at least one of the sensors 126 as radar sensors 510 with sensing arcs 512 configured to generate sensor data corresponding to objects in the surrounding area of the refuse vehicle 10. In some embodiments, the radar sensors 510 may be positioned on the exterior of the refuse vehicle 10 such that the sensing arcs 512 of the radar sensors 510 overlap to generate a 360-degree sensing area. In some embodiments, the radar sensors 510 are a combination of long and short-range sensors.

Referring to FIG. 8B, according to some embodiments, the awareness system 500 may include at least one of the sensors 126 as camera sensors 520 with sensing arcs 522. In some embodiments, the camera sensors 520 may be positioned on the exterior of the refuse vehicle 10 such that the sensing arcs 522 of the camera sensors 520 overlap to generate a 360-degree sensing area. In some embodiments, the camera sensors 520 are a combination of narrow-angle sensors and wide-angle sensors. The camera sensors 520 may generate image data corresponding to the sensing arcs 522.

Referring to FIG. 8C, according to some embodiments, the awareness system 500 may include a combination of the radar sensors 510 with the sensing arcs 512 and the camera sensors 520 with the sensing arcs 522. The sensing arcs 512 of the radar sensors 510 and the sensing arcs 522 of the camera sensors 520 may combine to provide 360 or near-360 degree coverage of the perimeter of the refuse vehicle 10.

It should be understood that the positioning and arrangement of the radar sensors 510 and the camera sensors 520 as described herein with reference to FIGS. 8A-8C is illustrative only and is not intended to be limiting. For example, any of the radar sensors 510 or the camera sensors 520 may be disposed on a top of the cab 16 such that the radar sensors 510 or the camera sensors 520 are configured to detect the presence and relative distance or position of overhead objects, obstacles, etc., proximate the cab 16.

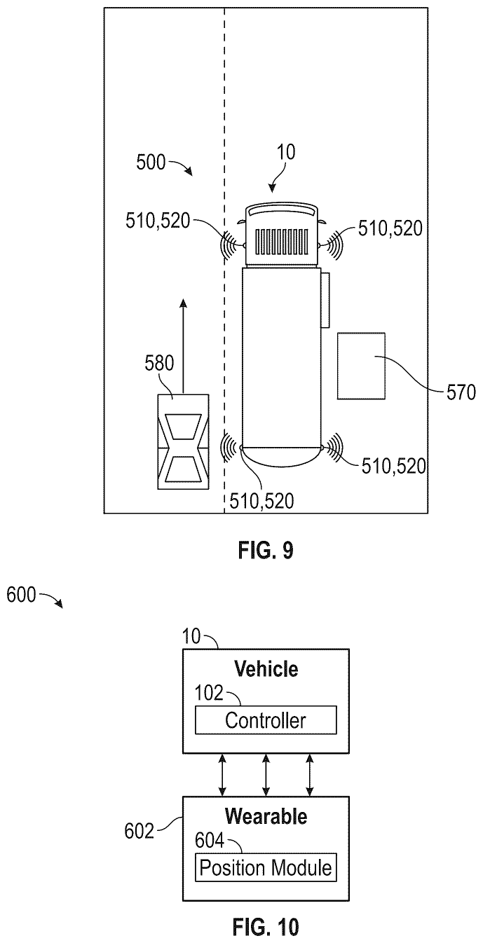

Referring to FIG. 9, the awareness system 500 may be configured to detect stationary objects proximate the refuse vehicle 10. For example, at least one of the radar sensors 510 or the camera sensors 520 may generate sensor data corresponding to the presence and/or the location of a stationary object, shown as refuse container 570, positioned proximate the refuse vehicle 10.

Still referring to FIG. 9, the awareness system 500 may be configured to detect moving objects proximate the refuse vehicle 10. For example, at least one of the radar sensors 510 or the camera sensors 520 may generate sensor data corresponding to the presence and/or the location of a moving object, shown as second vehicle 580, positioned proximate the refuse vehicle 10. In some embodiments, the awareness system 500 is configured to detect moving objects proximate the refuse vehicle 10 over a time frame such that the awareness system 500 can detect a velocity of the moving objects relative to the refuse vehicle 10 as the objects approach the refuse vehicle 10.

### Wearable System

Referring to FIG. 10, a block diagram of a wearable system 600 is shown, according to some embodiments. Each system and/or component of the wearable system 600 can include one or more processors, memory, network interfaces, communication interfaces, and/or user interfaces. Memory can store programming logic that, when executed by the processor, controls the operation of the corresponding computing system or device. Memory can also store data in databases. The network interfaces can allow the systems and/or components of the wearable system 600 to communicate wirelessly. The communication interfaces can include wired and/or wireless communication interfaces and the systems and/or components of the wearable system 600 can be connected via the communication interfaces. The various components in the wearable system 600 can be implemented via hardware (e.g., circuitry), software (e.g., executable code), or any combination thereof. Systems, devices, and components in FIG. 9 can be added, deleted, integrated, separated, and/or rearranged. The wearable system 600 may implement any of the functionality as described in greater detail in U.S. Application No. 63/529,878, filed Jul. 31, 2021, the entire disclosure of which is incorporated by reference herein.

The wearable system 600 may include at least one of the refuse vehicle 10 and at least one wearable and/or wearable device 602. The refuse vehicle 10 may include the various vehicles described herein. The wearable device 602 includes position module 604. The position module 604 may wirelessly communicate with the controller 102 of the vehicle through the telematics unit 132. In some embodiments, the wireless signals may include short-range signals. For example, the short-range signals may include signals in the Ultra-Wideband (UWB) spectrum. The short-range signals may also include other possible wired and/or wireless signal transmission. For example, the short-range signals may include signals transmitted via a Controller Area Network (CAN).

In some embodiments, the wearable device 602 includes and/or is implemented as at least one of a hardhat, a high visibility article of clothing, a watch, a band, a strap, or a pin. For example, the wearable device 602 can be disposed and/or otherwise including a hardhat. The wearable device 602 may be worn by at least one individual. For example, the wearable device 602 may be worn by an operator of the refuse vehicle 10. The wearable device 602 may also be worn by at least one individual located at and/or proximate to a post-collection site. For example, the wearable device 602 may be worn by a refuse collection worker.

The processing circuits 104 of the refuse vehicle 10 may generate, detect, identify, and/or otherwise determine a distance and/or a position of the refuse vehicle 10 relative to the wearable device 602 and/or the wearable device 602 relative to the refuse vehicle 10. For example, a position of the refuse vehicle 10 may be considered an origin and/or a default position and the position of the wearable device 602 may be determined relative to position of the refuse vehicle 10.

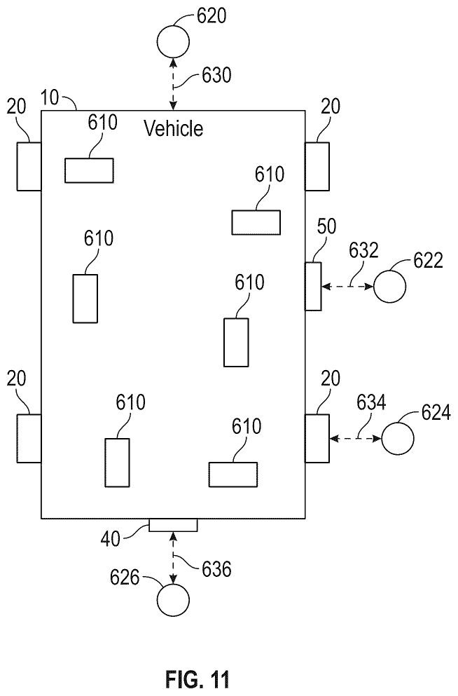

Referring to FIG. 11, the refuse vehicle 10 may include one or more vehicle position modules 610 disposed on various portions of the refuse vehicle 10. The one or more additional position modules 610 may be disposed at fixed portions and/or known positions of the refuse vehicle 10 (e.g., portions of the refuse vehicle 10 that may stay relative unchanged). The processing circuits 104 may determine the position of the wearable device 602 based on various aspects of the signals provided to the processing circuits 104. For example, the processing circuits 104 may know a given transmission speed of the signals and then determine the position of the wearable device 602 based on how long it took for the vehicle position modules 610 to receive the signals.

Still referring to FIG. 8, examples of positions of the wearable device 602 relative to the refuse vehicle 10 are shown. The positions include a plurality of points (e.g., points 620, 622, 624, and 626). Point 620 is shown to a distance 630 away from a front region of the refuse vehicle 10. Point 622 is shown to be a distance 632 away from the lift assembly 50. Point 624 is shown to be a distance 634 from one of the tractive elements 20. Point 626 is shown to be a distance 636 away from a rear portion of the refuse vehicle 10.

### Object Detection Control System

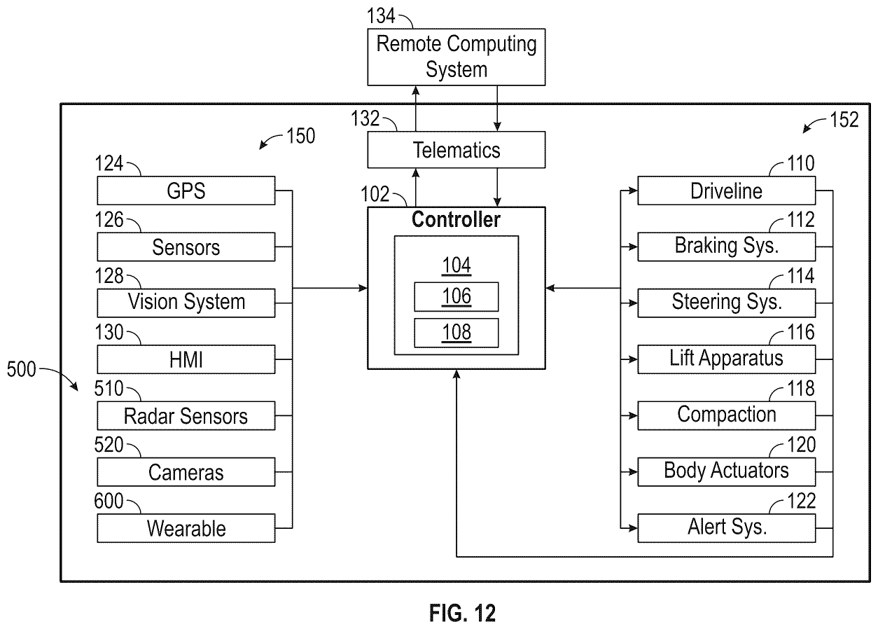

Referring to FIG. 12, the controller 102 may be configured to receive data from the radar sensors 510, the camera sensors 520, and the wearable system 600 and use the data to operate the driveline 110, the braking system 112, the steering system 114, the alert system 122, etc. The controller 102 may communicate with the remote computing system 134 via the telematics unit 132. The controller 102 may upload any of the data obtained from the GPS system 124, the awareness system 500, the wearable system 600, etc., to the remote computing system 134 and receive instructions from the remote computing system 134 (e.g., a control signal to reduce a risk to an operator). The controller 102 may use the instructions in combination with awareness data from the awareness system 500 in order to operate the driveline 110, the braking system 112, and the steering system 114 to autonomously place the refuse vehicle 10 in a parking configuration.

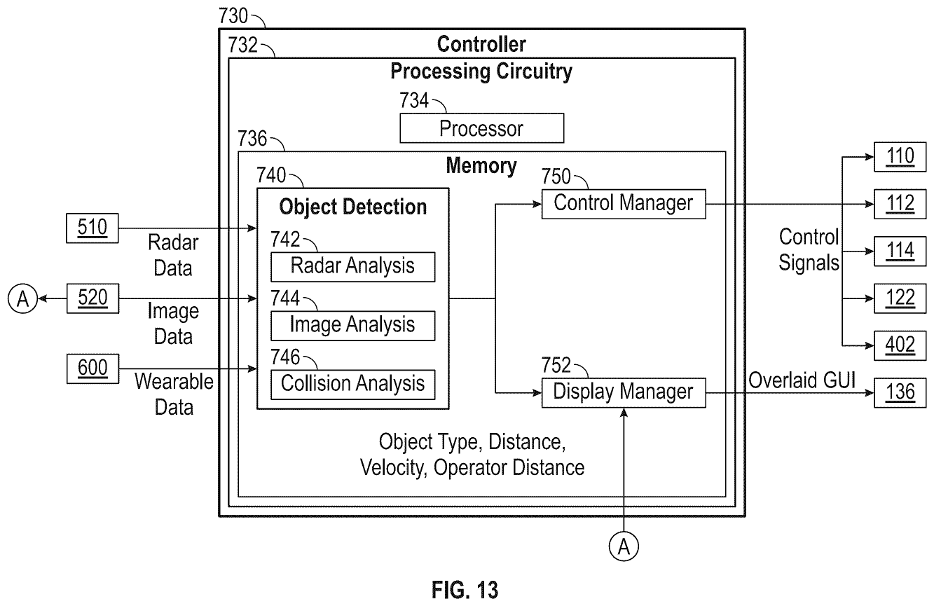

Referring to FIG. 13, a controller 730 is configured to receive radar data from the radar sensors 510 and image data from the camera sensors 520. In some embodiments, the controller 730 is configured to receive wearable data from the wearable system 600. The controller 730 includes one or more processing circuits 732 (e.g., processing circuitry, etc.) including a processor 734 and memory 736. The processing circuits 732 can be communicably connected with a communications interface of controller 730 such that the processing circuits 732 and the various components thereof can send and receive data via the communications interface. Processor 734 can be implemented as a general purpose processor, an application specific integrated circuit (ASIC), one or more field programmable gate arrays (FPGAs), a group of processing components, or other suitable electronic processing components.

Memory 736 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 736 can be or include volatile memory or non-volatile memory. Memory 736 can include database components, object code components, script components, or any other type of information structure for supporting the various activities and information structures described in the present application. According to some embodiments, memory 736 is communicably connected to processor 734 via the processing circuits 732 and includes computer code for executing (e.g., by at least one of the processing circuits 732 or processor 734) one or more processes described herein.

The memory 736 includes an object detection manager 740 that is configured to receive the radar data the image data and detect an object using any of or any combination of the radar data and the image data. The object detection manager 740 may be configured determine a type of the object, a distance of the object relative to the refuse vehicle 10, and a velocity of the object relative to the refuse vehicle 10. For example, the object detection manager 740 may be configured to perform various analyses based on each of the radar data and the image data in order to determine the type of object, to identify the position (e.g., distance) of the object relative to the refuse vehicle 10, and to identify a velocity of the object relative to the refuse vehicle 10. The object detection manager 740 is configured to implement a radar analysis technique 742 and an image analysis technique 744.

In some embodiments, the object detection manager 740 is configured to receive the wearable data and determine a position of the wearable device 602 worn by the operator of the refuse vehicle 10. For example, the object detection manager 740 may be configured to perform various analyses based on the wearable data in order to identify the position of the operator relative to the refuse vehicle 10. In some embodiments, the object detection manager is configured to implement a collision analysis technique 746.

The radar analysis technique 742 can include implementing radar recognition technology (e.g., a neural network, machine learning, artificial intelligence, etc.) to detect types of objects or obstacles that are nearby the refuse vehicle 10. The radar analysis technique 742 may use a database of predetermined objects and labels (e.g., vehicles, refuse containers, buildings, etc., or any other objects that may be commonly encountered nearby the refuse vehicle 10). The radar analysis technique 742 may be implemented in order to determine the type of object. In some embodiments, the radar analysis technique 742 is also configured to estimate the distance between the refuse vehicle 10 and the object. For example, if the awareness system 500 includes multiple of the radar sensors 510, the object detection manager 740 may use a comparison between the multiple of the radar sensors 510 having different perspectives to identify an estimated distance between the refuse vehicle 10 and the object. In some embodiments, the radar analysis technique 742 is also configured to estimate the velocity of the object relative to the refuse vehicle 10. For example, the object detection manager 740 may use a comparison between the radar data from the radar sensors 510 from different moments of time to identify an estimated velocity of the object relative to the refuse vehicle 10.

The image analysis technique 744 can include implementing image recognition technology (e.g., a neural network, machine learning, artificial intelligence, etc.) to detect types of objects that are nearby the refuse vehicle 10. The image analysis technique 744 may use a database of predetermined objects and labels (e.g., vehicles, refuse containers, buildings, etc., or any other objects that may be commonly encountered nearby the refuse vehicle 10). The image analysis technique 744 may be implemented in order to determine the type of objects. In some embodiments, the image analysis technique 744 is also configured to estimate the distance between the refuse vehicle 10 and the objects. For example, if the awareness system 500 includes multiple of the camera sensors 520, the object detection manager 740 may use a comparison between the multiple of the camera sensors 520 having different perspectives to identify an estimated distance between the refuse vehicle 10 and the object. In some embodiments, the image analysis technique 744 is also configured to estimate the velocity of the object relative to the refuse vehicle 10. For example, the object detection manager 740 may use a comparison between the image data from the camera sensors 520 from different moments of time to identify an estimated velocity of the object relative to the refuse vehicle 10. In some embodiments, the object detection manager 740 may use a combination of the radar analysis technique 742 and the image analysis technique 744 to detect types of objects that are nearby the refuse vehicle 10, the distance between the refuse vehicle 10 and the objects, and the velocity of the objects relative to the refuse vehicle 10.

The collision analysis technique 746 can include implementing collision detection technology (e.g., a neural network, machine learning, artificial intelligence, etc.) to predict contact between objects. The collision analysis technique may use a database of predetermined collision parameters (e.g., a velocity of a second vehicle relative to the refuse vehicle 10, etc.). In some embodiments, the collision analysis techniques 746 may use the outputs of at least one of the radar analysis technique 742 or the image analysis technique 744. The collision analysis technique 746 may be implemented in order to predict that an object may come in contact with the refuse vehicle 10. For example, the collision analysis technique 746 may be implemented to predict that a second vehicle may come in contact with the refuse vehicle 10 based on the type, the position, and the velocity of the second vehicle. In some embodiments, the collision analysis technique 746 may be implemented in order to predict that the object may come in contact with a specific portion of the refuse vehicle 10. For example, the collision analysis technique 746 may be implemented to predict that the second vehicle may come in contact with one of the doors 402 of the refuse vehicle 10 if the one of the doors 402 is positioned in an open configuration. In some embodiments, the collision analysis technique 746 is also configured to predict that an object may come in contact with the operator of the refuse vehicle 10. In some embodiments, the collision analysis technique 746 may use the wearable data from the wearable system 600. For example, when the operator is positioned outside of the refuse vehicle 10, the collision analysis technique 746 may be implemented to predict that a second vehicle may come in contact with the operator of the refuse vehicle 10.

Referring still to FIG. 10, the memory 736 further includes a control manager 750 and a display manager 752. The control manager 750 is configured to use outputs of the object detection manager 740 in order to implement autonomous operation of the refuse vehicle 10. The control manager 750 can generate control signals for the driveline 110, the braking system 112, the steering system 114, the alert system 122, or other components of the controllable elements 152. For example, the control manager 750 can generate control signals for the opening mechanism 408 of the door 402 (e.g., generate control signals for an actuator coupled to the opening mechanism 408, etc.) to activate the opening mechanism 408 to keep the door 402 in a closed position. In some embodiments, the control manager 750 is configured to operate the driveline 110, the braking system 112, and the steering system 114 to autonomously place the refuse vehicle 10 in a parking configuration (e.g., by engaging the parking brake, by placing the transmission 22 in a neutral orientation, etc.). For example, the control manager 750 may be configured to operate the driveline 110, the braking system 112, and the steering system 114 to adjust the refuse vehicle 10 from a non-parking configuration to the parking configuration. 60 In some embodiments, the control manager 750 is configured to operate the alert system 122 to provide an alert to individuals nearby the refuse vehicle 10. In some embodiments, the control manager 750 is configured to operate the door 402 to adjust the orientation of the door 402 (e.g., activate the opening mechanism 408 to keep the door 402 in the closed orientation, etc.).

The display manager 752 is configured generate a graphical user interface (“GUI”) for an operator or user of the refuse vehicle 10 based on the results of the object detection manager 740. The display manager 752 is configured to obtain the results of the object detection manager 740 and produce graphical displays of any objects that are detected. The display manager 752 is configured to generate an overlaid GUI and provide the overlaid GUI to a user interface 136 (e.g., a display screen, a touch screen, etc.). The overlaid GUI may include ghost or phantom images of the objects detected by the object detection manager 740 superimposed over image data of a surrounding area of the refuse vehicle 10. The user interface 136 may be positioned locally at the refuse vehicle 10 or may be at a remote location (e.g., at an operator or technician center for fleet management purposes).

Referring still to FIG. 10, it should be understood that any of the functionality of the controller 730 may be implemented on the controller 102 of each of a fleet of refuse vehicles 10. In some embodiments, one or more functions of the controller 730 are implemented by the controller 102 and one or more functions of the controller 730 are implemented by the remote computing system 134 with which the controller 102 is in communication. Accordingly, any of the functionality of the controller 730 may be performed in a distributed manner between the controller 102 and the remote computing system 134.

### Driver Presence and Location Process

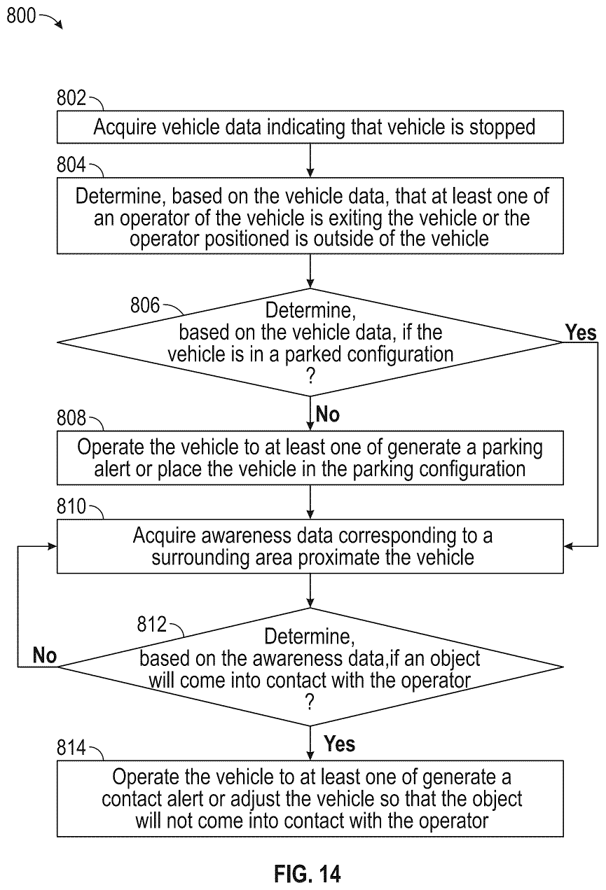

Referring to FIG. 14, a flow diagram of a process 800 for operating a vehicle to protect an operator of the vehicle includes steps 802-814, according to some embodiments. In some embodiments, the process 800 is performed by the controller 102 based on data obtained from one or more of the input devices 150 of the refuse vehicle 10. In some embodiments, the process 800 is performed by the controller 730 based on data obtained from the awareness system 500 and the wearable system 600 of the refuse vehicle 10. The process 800 may be implemented in order to protect an operator exiting the refuse vehicle 10, or to place the refuse vehicle 10 into a parked configuration when the operator is exiting the refuse vehicle 10 or when the operator is not in the refuse vehicle 10.

The process 800 includes acquiring vehicle data indicating that the vehicle is stopped (step 802), according to some embodiments. Step 802 can be performed by the controller 102 by obtaining vehicle data from one or more of the input devices 150. The vehicle data may indicate that the refuse vehicle 10 is stopped (e.g., not moving, parked, etc.). For example, the vehicle data received by the controller 102 may include GPS data from the GPS system 124 indicating that the position of the refuse vehicle 10 is not changing, sensor data from the sensors 126 indicating that the refuse vehicle 10 is not moving (e.g., sensor data from a potentiometer, sensor data from an accelerometer, etc.), awareness data from the awareness system 500, wearable data from the wearable system 600, or user inputs from the HMI 130.

The process 800 also includes determining that at least one of an operator of the vehicle is exiting the vehicle or the operator is outside of the vehicle (step 804), according to some embodiments. Step 804 can be performed by the controller 102 based on the vehicle data obtained from the one or more of the input devices 150. In some embodiments, the process 800 includes determining that an operator of the vehicle is exiting the vehicle or that the operator is outside of the vehicle using the vehicle data. In some embodiments, the controller 102 may determine that the operator of the refuse vehicle 10 is exiting the cab 16 of the refuse vehicle 10. In some embodiments, the controller 102 may determine that the operator of the refuse vehicle 10 is exiting the cab 16 by identifying a change in the sensor data received from the seat sensor 414 (e.g., that the operator is no longer supported by the seat support 412, etc.), a change in the sensor data received from the seat belt sensor 418 (e.g., that the seat belt 416 is no longer securing the operator to the seat support 412, etc.), a change in the sensor data received from the door sensor 406 (e.g., that the door 402 has been adjusted from the closed configuration to an open configuration, that the opening mechanism 408 is not keeping the door 402 in the closed position, etc.), or a change in sensor data received from the shift input sensor (e.g., that the shift input device 424 has been adjusted to the park orientation, etc.). In various embodiments, the controller 102 may determine that the operator of the refuse vehicle 10 is exiting the cab 16 through other components of the vehicle data (e.g., through the image data received from the vision system 128, through the user inputs received from the HMI 130, etc.).

In some embodiments, the controller may determine that the operator of the refuse vehicle 10 is outside of the refuse vehicle 10 by identifying a position of the wearable device 602 worn by the operator (e.g., that the position of the wearable device 602 worn by the operator is outside of the refuse vehicle 10, etc.), by identifying a position of the operator through the image data received from the vision system 128 (e.g., identifying the operator in the image data and determining that the operator is outside of the refuse vehicle 10, etc.), or by identifying a position of the operator through the user inputs received from the HMI 130 (e.g., receiving a user input from an input device of the HMI 130 that is located outside of the refuse vehicle 10, etc.).

The process 800 also includes determining if the vehicle is in a parked configuration (step 806), according to some embodiments. Step 806 may be performed by the controller 102 based on the vehicle data. In some embodiments, the parked configuration may include that at least one of the parking brake of the refuse vehicle 10 is engaged or the transmission 22 is in the neutral orientation. In some embodiments, the controller 102 may identify if the refuse vehicle 10 is in the parked configuration by determining if the parking brake of the refuse vehicle 10 is engaged using the sensor data obtained from the parking brake sensor 432. In some embodiments, the controller 102 may identify if the refuse vehicle 10 is in the parked configuration by determining if the shift input device 424 is in the neutral position using the sensor data obtained from the shift input sensor 430. In various embodiments, the controller 102 may identify if the refuse vehicle 10 is in the parked configuration by determining if the parking brake of the refuse vehicle 10 is engaged and if the shift input device 424 is in the neutral position.

In response to determining that the vehicle is in the parked configuration (step 806, “YES”), process 800 proceeds to step 810. In response to determining that the vehicle is not being in the parked configuration (step 806, “NO”), process 800 proceeds to step 808.

The process 800 also includes operating the vehicle to at least one of generate a parking alert or place the vehicle in the parked configuration (step 808), according to some embodiments. Step 808 can include generating a parking alert for an alert system. Step 808 can also include generating controls for a driveline, braking system, a steering system, etc. of the refuse vehicle in order to place the vehicle in the parked configuration. In some embodiments, step 808 can be performed by the controller 102 by generating a parking alert and providing the alert to the alert system 122. For example, the controller 102 may generate the parking alert including a parking alarm indicating that the refuse vehicle 10 is not in the parked configuration and provide the parking alert to the alert system 122. The alert system 122 may provide the parking alarm to nearby individuals (e.g., the operator, etc.) as an aural alert or a visual alert to notify the nearby individuals that the vehicle is not in the parked configuration. The aural alert or the visual alert may notify the operator of the refuse vehicle 10 that the refuse vehicle 10 is not in the parked configuration such that the operator may place the refuse vehicle 10 in the parked configuration.

In some embodiments, step 808 can be performed by the controller 102 by generating controls for the driveline 110, the braking system 112, or the steering system 114 to place the refuse vehicle 10 in the parked configuration. For example, the controller 102 may generate controls for the braking system 112 to engage the parking brake of the refuse vehicle 10 in order to engage the parking brake of the refuse vehicle 10. As another example, the controller 102 may generate controls for the driveline 110 to adjust the transmission 22 to the neutral orientation in order to adjust the transmission 22 to the neutral orientation.

The process 800 also includes acquiring awareness data corresponding to a surrounding area proximate the vehicle (step 810), according to some embodiments. Step 810 can include obtaining the awareness data from an awareness system of the vehicle that includes detection of objects positioned within the surrounding area. Step 810 can be performed by the controller 102 by obtaining the awareness data from the awareness system 500. For example, the awareness data from the awareness system 500 may include detection of an object by one of the radar sensors 510 within the sensing arc 512 of the radar sensor 510 or detection of an object by one of the camera sensors 520 within the sensing arc 522 of the camera sensor 520. In some embodiments, the awareness data may include the wearable data from the wearable system 600 indicating a position of the wearable device 602 worn by the operator of the refuse vehicle 10.

The process 800 also includes determining if an object will come into contact with the operator (step 812), according to some embodiments. In some embodiments, step 812 includes predicting that the operator may come in contact with an object or that the object may come in contact with the operator. Step 812 may be performed by the controller 102 based on the vehicle data corresponding to the refuse vehicle 10 and the awareness data from the awareness system 500 corresponding to the surrounding area of the refuse vehicle 10. In some embodiments, the controller 102 may predict that the operator may come in contact with the object after determining that the operator is exiting the refuse vehicle 10 using the vehicle data in step 804. The controller 102 may analyze the awareness data from the awareness system 500 and predict that the operator may come in contact with an object if the object is proximate the refuse vehicle 10. In some embodiments, the controller 102 may predict that the operator may come in contact with the object if the object is proximate at least one of the doors 402 of the cab 16. For example, the awareness data from the awareness system 500 may indicate that a refuse container is proximate the door 402 of the refuse vehicle 10 that the operator is exiting. The controller 102 may predict that the operator may come in contact with the refuse container with the door 402.

In some embodiments, the controller 102 may analyze the awareness data from the awareness system 500 and predict that the operator may come in contact with an object that is approaching the refuse vehicle 10. In some embodiments, the controller 102 may analyze the awareness data and predict that the operator may come in contact with an object if the object is approaching at least one of the doors 402 of the cab 16 (e.g., a trajectory of the object intersects with the at least one of the doors 402 of the cab 16, etc.). For example, the awareness data from the awareness system 500 may indicate that a second vehicle is approaching the door 402 of the refuse vehicle 10 and that the operator is exiting the door 402. The controller 102 may predict that the operator may come in contact with the second vehicle that is approaching the door 402 of the refuse vehicle 10 since the operator is exiting the door 402.

In some embodiments, the controller 102 may predict that the operator may come in contact with an object after identifying that the operator is outside of the refuse vehicle 10 using the vehicle data in step 804. The controller 102 may analyze the image data received from the vision system 128 and predict that the operator outside of the refuse vehicle 10 may come in contact with an object if the object is approaching the refuse vehicle 10. For example, the visual data received from the vision system 128 may detect that a second vehicle is approaching the refuse vehicle 10. The controller 102 may predict that the operator may come in contact with the second vehicle that is approaching the refuse vehicle 10 since the operator is outside of the refuse vehicle 10.

In some embodiments, the controller 102 may predict that the operator may come in contact with an object after determining a position of the operator outside of the refuse vehicle 10 and determining that an object is approaching the position of the operator outside of the refuse vehicle 10. For example, the controller 102 may determine that the object is moving toward the operator based on a trajectory of the object intersecting with the position of the operator. The controller 102 may determine the position of the operator outside of the vehicle by determining the position of the wearable device 602 worn by the operator using the wearable data from the wearable system 600 or by determining the position of the operator using the awareness data received from the awareness system 500. For example, the controller 102 may analyze the awareness data received from the awareness system 500 and identify the position of the operator based on the awareness data received from the awareness system 500. The controller 102 may then analyze the awareness data received from the awareness system 500 and predict that the operator may come in contact with an object approaching the position of the operator outside of the refuse vehicle 10. For example, the controller 102 may analyze the awareness data received from the awareness system 500 to determine a position of the operator outside of the refuse vehicle 10 and that a second vehicle is approaching the position of the operator. The controller 102 may predict that the operator may come in contact with the second vehicle since the second vehicle is approaching the position of the operator. As another example, the controller 102 may analyze the wearable data received from the wearable system 600 to determine a position of the operator outside of the refuse vehicle 10 and the awareness data received from the awareness system 500 to determine that a second vehicle is approaching the position of the operator. The controller 102 may predict that the operator may come in contact with the second vehicle since the second vehicle is approaching the position of the operator.

In response to determining that the object will come into contact with the operator (step 812 “YES”), process 800 proceeds to step 814. In response to determining that the object will not come into contact with the operator (step 812, “NO”), process 800 returns to step 810.

The process 800 also includes operating the vehicle to at least one of generate a contact alert or adjust the vehicle so that the object will not come into contact with the operator (step 814), according to some embodiments. Step 814 can include generating an operator alert for an alert system. Step 814 can also include generating controls for a driveline, a braking system, a steering system, etc. of the refuse vehicle so that the operator may not come in contact with the object. In some embodiments, step 814 can be performed by the controller 102 by generating an operator alert and providing the alert to the alert system 122. For example, the controller 102 may generate the operator alert including an operator alarm indicating that the operator is at risk and provide the operator alert to the alert system 122. The alert system 122 may provide the operator alarm to nearby individuals (e.g., the operator, etc.) as an aural alert or a visual alert to notify the nearby individuals that the operator is at risk. The aural alert or the visual alert may notify the operator of the refuse vehicle 10 that the operator is at risk such that the operator may take actions to reduce the risk to the operator. In some embodiments, the operator alert may differ from the parking alert generated in step 808 such that the nearby individuals can tell a difference between the operator alert and the parking alert.

In some embodiments, step 814 can be performed by the controller 102 by generating controls for the driveline 110, the braking system 112, the steering system 114, or one of the controllable elements 152 to so that the operator may not come in contact with the object. For example, if the controller 102 predicts that the operator may come in contact with a second vehicle approaching the door 402 of the refuse vehicle 10 since the operator is exiting the door 402, the controller 102 may generate controls for the opening mechanism 408 of the door 402 to activate the opening mechanism 408 to keep the door 402 in a closed position such that the operator can not exit the door 402. As another example, if the controller 102 predicts that the operator may come in contact with a second vehicle approaching the refuse vehicle 10, the controller 102 may generate controls for the driveline 110 to transport the refuse vehicle 10 to a position that blocks a path between the second vehicle and the operator such that the second vehicle may not come in contact with the operator.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a driveline configured to transport the refuse vehicle;
a cab defining a cab opening configured to receive an operator of the refuse vehicle therein;
one or more sensors configured to generate sensor data corresponding to at least one of the refuse vehicle or the operator; and
one or more processing circuits configured to:
acquire, from the one or more sensors, the sensor data;
determine, based on the sensor data, an operator of the refuse vehicle is at least one of exiting the cab opening or is positioned outside of the cab opening;
determine, based on the sensor data, that the refuse vehicle is in a non-parking configuration; and
operate the refuse vehicle to place the refuse vehicle in a parking configuration.

2. The refuse vehicle of claim 1, further comprising:
a parking brake system configured to be alternated between a deactivated configuration where the parking brake system allows for transport of the refuse vehicle and an activated configuration where the parking brake system prevents transport of the refuse vehicle;
wherein the one or more processing circuits are configured to adjust the refuse vehicle from the non-parking configuration to the parking configuration by adjusting the parking brake system from the deactivated configuration to the activated configuration.

3. The refuse vehicle of claim 2, wherein the one or more processing circuits are configured to determine the refuse vehicle is not in the parking configuration based on the sensor data indicating the parking brake system is in the deactivated configuration.

4. The refuse vehicle of claim 1, wherein:
the cab comprises a door configured to provide access to the cab opening of the cab;
the one or more sensors include a door sensor configured to generate a portion of the sensor data corresponding to an orientation of the door; and
the one or more processing circuits are configured to determine an operator of the refuse vehicle is at least one of exiting the cab opening or is positioned outside of the cab opening based on the portion of the sensor data.

5. The refuse vehicle of claim 1, wherein:
the cab comprises at least one of:
a seat support configured to support the operator of the refuse vehicle; or
a seat belt configured to secure the operator to the seat support;
the one or more sensors include a seat sensor configured to generate a portion of the sensor data corresponding to at least one of the seat support or the seat belt; and
the one or more processing circuits are configured to determine an operator of the refuse vehicle is at least one of exiting the cab opening or is positioned outside of the cab opening based on the portion of the sensor data.

6. The refuse vehicle of claim 1, further comprising an awareness system configured to generate awareness data corresponding to surroundings of the refuse vehicle;
wherein the one or more processing circuits are further configured to:
acquire, from the awareness system, the awareness data;
determine, based on the awareness data, an object will contact the operator; and
operate the refuse vehicle to generate a contact alert.

7. The refuse vehicle of claim 6, wherein the one or more processing circuits are configured to acquire the awareness data responsive to determining the operator of the refuse vehicle is at least one of exiting the cab opening or is positioned outside of the cab opening.

8. The refuse vehicle of claim 6, wherein:
the one or more processing circuits are further configured to:
determine, based on the sensor data, a position of the operator outside of the cab opening; and
the one or more processing circuits determine the object will contact the operator based on a trajectory of the object intersecting with the position of the operator.

9. The refuse vehicle of claim 6, wherein the one or more processing circuits are further configured to:
operate the refuse vehicle to place the refuse vehicle in the non-parking configuration; and
operate the refuse vehicle to transport the refuse vehicle such that the refuse vehicle is positioned between the object and the operator.

10. A refuse vehicle comprising:
a driveline configured to transport the refuse vehicle;
a cab defining a cab opening configured to receive an operator of the refuse vehicle therein;
one or more sensors configured to generate sensor data corresponding to at least one of the refuse vehicle or the operator;
an awareness system configured to generate awareness data corresponding to surroundings of the refuse vehicle; and
one or more processing circuits configured to:
acquire, from the one or more sensors, the sensor data;
determine, based on the sensor data, a position of the operator;
acquire, from the awareness system, the awareness data;
determine, based on the awareness data, an object is approaching the position of the operator; and
operate the refuse vehicle to generate a contact alert such that the operator is alerted the object is approaching the position of the operator.

11. The refuse vehicle of claim 10, wherein the one or more processing circuits are configured to acquire the awareness data responsive to the position of the operator being outside of the cab opening.

12. The refuse vehicle of claim 10, wherein the one or more processing circuits are further configured to:
operate the refuse vehicle to transport the refuse vehicle such that the refuse vehicle is positioned between the object and the operator.

13. The refuse vehicle of claim 10, wherein the one or more processing circuits are further configured to:
determine, based on the sensor data, the refuse vehicle is in a non-parking configuration; and
responsive to the position of the operator being outside of the cab opening, operate the refuse vehicle to place the refuse vehicle in a parking configuration.

14. The refuse vehicle of claim 10, wherein:
the one or more sensors include a wearable device worn by the operator configured to generate a portion of the sensor data associated with the position of the operator; and
the one or more processing circuits determine the position of the operator based on the portion of the sensor data.

15. The refuse vehicle of claim 10, wherein:
at least one of the one or more sensors is a camera configured to generate image data corresponding to the surroundings of the refuse vehicle;
the awareness system generates the awareness data based on the image data;
the one or more processing circuits are configured to determine the position of the operator based on the image data; and
the one or more processing circuits are configured to determine the object is approaching the position of the operator based on the image data.

16. A method for operating a refuse vehicle, the method comprising:
acquiring, from one or more sensors of the refuse vehicle, sensor data corresponding to the refuse vehicle;
determining, based on the sensor data, an operator of the refuse vehicle is positioned outside of the refuse vehicle;
determining, based on the sensor data, the refuse vehicle is in a non-parking configuration; and
operating the refuse vehicle to at least one of generate a parking alert or place the refuse vehicle in a parking configuration.

17. The method of claim 16, further comprising:
acquiring, from the one or more sensors of the refuse vehicle, surrounding data corresponding to surroundings of the refuse vehicle;
determining, based on the surrounding data, a position of the operator of the refuse vehicle;
determining, based on the surrounding data, an object is approaching the position of the operator; and
operating the refuse vehicle to generate a contact alert such that the operator is alerted the object is approaching the position of the operator.

18. The method of claim 17, wherein the surrounding data is acquired in response to determining the operator of the refuse vehicle is positioned outside of the refuse vehicle.

19. The method of claim 17, further comprising:
operating the refuse vehicle to place the refuse vehicle in the non-parking configuration; and
operating the refuse vehicle to transport the refuse vehicle such that the refuse vehicle is positioned between the object and the operator.

20. The method of claim 16, wherein:
the one or more sensors include a wearable device worn by the operator configured to generate a portion of the sensor data associated with a position of the operator; and
the position of the operator is determined based on the portion of the sensor data.
